(19) United States
(12) Patent Application Publication
(10) Pub. No.: US 2007/0221296 A1
(43) Pub. Date: Sep. 27, 2007

(54) Rare Earth Sintered Magnet, Raw Material Alloy Powder For Rare Earth Sintered Magnet, And Process For Producing Rare Earth Sintered Magnet

(75) Inventors: Yasushi Enokido, Tokyo (JP); Atsushi Sakamoto, Tokyo (JP); Chikara Ishizaka, Tokyo (JP); Takeshi Masuda, Tokyo (JP); Masaaki Imura, Tokyo (JP)

Correspondence Address: PEARNE & GORDON LLP, 1801 EAST 9TH STREET, SUITE 1200, CLEVELAND, OH, 44114-3108, US

(73) Assignee: TDK CORPORATION, Chuo-ku, Tokyo (JP)

(21) Appl. No.: 11/568,823

(22) PCT Filed: Jun. 24, 2005
(86) PCT No.: PCT/JP05/11577

§ 371 Date: Nov. 8, 2006

(30) Foreign Application Priority Data
Jun. 25, 2004 (JP) 2004-188230
Feb. 24, 2005 (JP) 2005-048588
Feb. 24, 2005 (JP) 2005-048589
Feb. 28, 2005 (JP) 2005-052457
Mar. 17, 2005 (JP) 2005-077525

(51) Int. Cl. H01F 1/00; B22F 1/00

(52) U.S. Cl. 148/301; 148/103; 75/228

(57) ABSTRACT

Provided is a rare earth sintered magnet which can attain a high residual magnetic flux density without causing a drop in coercive force or mechanical strength. The above-described problems are resolved by a rare earth sintered magnet which includes a sintered body whose carbon amount as determined by mass spectrometry is between 500 and 1,500 ppm, wherein a cv-value of the carbon amount on a rupture plane thereof is no greater than 200. The production method for this rare earth sintered magnet includes the steps of: preparing a compacted body by compressing in a magnetic field a raw material alloy powder has a carbon amount of no greater than 1,200 ppm as determined by mass spectrometry, and a Cmax/Cmin value of 15 or less wherein Cmax and Cmin respectively represent a maximum value and a minimum value of X-ray intensity of characteristic X-rays of carbon as determined by EPMA (Electron Probe Micro Analyzer); and sintering the compacted body.

### TECHNICAL FIELD

The present invention relates to a rare earth sintered magnet as represented by a Nd—Fe—B system, and especially relates to a rare earth sintered magnet whose magnetic properties and mechanical strength are both high.

### BACKGROUND ART

Rare earth sintered magnets, as represented by a Nd—Fe—B system anisotropic sintered magnet, are widely used as high-performance magnets. To increase the residual magnetic flux density of a rare earth sintered magnet, it is important to improve orientation during compacting in a magnetic field. If orientation becomes higher, the squareness and magnetization rate improve. As a technique for improving orientation of a raw material alloy powder in a magnetic field, various processes to add a lubricant into the raw material alloy powder have been proposed.

For example, Patent Document 1 reports that orientation can be improved by increasing the dispersibility of a lubricant in a raw material alloy powder, by adding the lubricant during milling. Further, Patent Document 2 proposes the use of a liquefied lubricant wherein a saturated or unsaturated fatty acid ester and a borate ester or the like as an acid salt are dispersed in a petroleum solvent or an alcohol solvent.

Patent Document 1: Japanese Patent No. 2915560

Patent Document 2: Japanese Patent Laid-Open No. 8-111308

In order to improve the pulverizing properties of a raw material alloy during the pulverizing step and to improve orientation of a raw material alloy powder during the compacting step in a magnetic field, it is preferable to increase the additive amount of lubricant. However, if the amount of lubricant added is increased, the magnetic properties of the obtained rare earth sintered magnet drop. In other words, although the lubricant is removed during the sintering step, a portion still remains, and this portion exists in the interior of the rare earth sintered magnet mainly as rare earth carbides. These rare earth carbides are a factor in decreasing coercive force of the rare earth sintered magnet. If these rare earth carbides are segregated out, they become a starting point for rupture, and thus act as a factor in decreasing the mechanical strength.

In addition, if agglomerated particles of lubricant remain in the compacted body, voids caused by these agglomerated particles are formed after sintering in the sintered body. This is also the case even if a lubricant dispersed in a solvent is used, as in Patent Document 2. Furthermore, the strength of the compacted body drops as a result of the added lubricant. It is also known that it is difficult to obtain a sintered body having a desired dimensional accuracy, as peeling and fissures occur in the compacted body (e.g. refer to Patent Document 3).

Patent Document 3: Japanese Patent Laid-Open No. 7-240329

### DISCLOSURE OF THE INVENTION

As described above, while a lubricant is effective in improving orientation when compacting in a magnetic field, there is the danger of causing a drop in magnetic properties, especially coercive force, as well as a drop in mechanical strength. This trend is particularly marked if a large amount of lubricant is added in order to attain a high orientation.

The present invention was created in view of such technical problems. It is an object of the present invention to provide a rare earth sintered magnet capable of attaining high residual magnetic flux density, without causing a drop in coercive force and mechanical strength, even if a certain amount of lubricant is used.

As a result of investigations into the form in which the rare earth carbides attributable to the lubricant exist in the rare earth sintered magnet, a rather interesting phenomenon was discovered. Namely, in some cases there is a clear difference in magnetic properties, especially residual magnetic flux density and mechanical strength, of obtained rare earth sintered magnets even when the amount of lubricant added into the a raw material alloy during milling was the same. When such rare earth sintered magnets having differences in their residual magnetic flux density and mechanical strength were analyzed, the form in which the rare earth carbides existed was different. That is, it was learned that rare earth sintered magnets having high residual magnetic flux density and mechanical strength were superior in their dispersion state of the rare earth carbides. Thus, by controlling the dispersion state of the rare earth carbides in a rare earth sintered magnet, high residual magnetic flux density can be attained without causing a drop in coercive force or mechanical strength.

Based on the above investigations, a rare earth sintered magnet according to the present invention comprises a sintered body whose carbon amount as determined by mass spectrometry is between 500 and 1,500 ppm, and is characterized in that a cv-value (Coefficient of Variation) of carbon amount on a rupture plane thereof is no greater than 200.

According to the investigations conducted by the present inventors, a rare earth sintered magnet, whose cv-value of carbon amount is no greater than 200 and which has an excellent dispersion state, is difficult to obtain merely by simply adding a lubricant. For example, even if a lubricant is dispersed in a solvent, as in Patent Document 2, the lubricant particles agglomerate. Since it is impossible to break up the agglomerated state even by milling, it is difficult to obtain a high dispersion state of carbon whose cv-value of carbon amount is 200 or less in the rare earth sintered magnet. As a result of trial and error by the present inventors, it was found that using a lubricant having a fine particle size is a simple and effective technique for obtaining a high dispersion state of carbon. By employing such a technique, the production of a rare earth sintered magnet having a dispersion state wherein the cv-value of carbon amount is 200 or less has been made easy. It is noted that, as described above, since the carbon in the rare earth sintered magnet is entirely present as rare earth carbides, the dispersion state of carbon is equivalent to the dispersion state of the rare earth carbides.

In the rare earth sintered magnet according to the present invention, the cv-value of carbon amount is preferably no greater than 150, and even more preferably no greater than 130. In addition, the contained carbon amount is preferably between 700 and 1,300 ppm, and even more preferably between 800 and 1,200 ppm.

The rare earth sintered magnet applied in the present invention is preferably an R—Fe—B system sintered magnet which comprises as a main phase an R₂Fe₁₄B compound (wherein R represents one or more elements selected from among Y, La, Ce, Pr, Nd, Sm, Eu, Gd, Tb, Dy, Ho, Er, Tm, Yb and Lu). Further, such a rare earth sintered magnet can comprise the characteristics of a flexural strength of 350 MPa or greater, residual magnetic flux density (Br) of 13 kG or greater, and coercive force (HcJ) of 18 kOe or greater.

The lubricant, normally, is added during the milling of the raw material alloy of the rare earth sintered magnet. As a consequence of this milling, the lubricant covers the surface of the milled powder. If this coated state can be made uniform, orientation can be ensured when compacting in a magnetic field with a smaller amount of lubricant. Moreover, a milled powder wherein the lubricant is uniformly coated in such a manner is effective in producing the rare earth sintered magnet according to the present invention, since the amount of lubricant has been decreased so that the decrease in coercive force caused by lubricant (carbon) remaining is suppressed. Based on this, the present inventors investigated the coated state of the lubricant in the milled powder and the magnetic properties of a rare earth sintered magnet produced using such a milled powder. As a result, it was discovered that the coated state of the lubricant could be determined by the concentration distribution of carbon (C) of the milled powder surface, and that a rare earth sintered magnet having excellent magnetic properties in which residual magnetic flux density was high could be obtained while suppressing the drop in coercive force by setting the carbon to a certain concentration distribution.

Specifically, the present invention provides a raw material alloy powder for a rare earth sintered magnet to be used for compacting in a magnetic field, wherein carbon amount as determined by mass spectrometry is no greater than 1,200 ppm, and Cmax/Cmin is 15 or less (wherein Cmax and Cmin respectively represent a maximum value and a minimum value of X-ray intensity of characteristic X-rays of carbon as determined by EPMA (Electron Probe Micro Analyzer)).

In the raw material alloy powder of the present invention, carbon amount as determined by mass spectrometry of no greater than 1,000 ppm, and Cmax/Cmin of 10 or less is preferable in terms of attaining a high residual magnetic flux density and coercive force.

In the present invention, as described above the reason why carbon is detected is that a lubricant comprising an organic compound is coated on the surface of the raw material alloy powder. Thus, a Cmax/Cmin of this lubricant being 15 or less, or even 10 or less or 5 or less (i.e. the lower the value), indicates that the lubricant is coated uniformly on the surface of the raw material alloy powder.

A process for producing a rare earth sintered magnet using the raw material alloy powder for the rare earth sintered magnet according to the present invention comprises the steps of: preparing a compacted body by compressing in a magnetic field a raw material alloy powder whose carbon amount as determined by mass spectrometry is no greater than 1,200 ppm, and whose Cmax/Cmin is 15 or less (wherein Cmax and Cmin respectively represent a maximum value and a minimum value of X-ray intensity of characteristic X-rays of carbon as determined by EPMA (Electron Probe Micro Analyzer)); and sintering the compacted body.

A raw material alloy powder having such a carbon amount and a Cmax/Cmin can be obtained by being pulverized with lubricant particles having a particle size of 425 μm or less added therein. These lubricant particles can be obtained by pulverizing a solid lubricant. The raw material alloy powder also preferably comprises an R₂Fe₁₄B compound (wherein R represents one or more elements selected from among Y, La, Ce, Pr, Nd, Sm, Eu, Gd, Tb, Dy, Ho, Er, Tm, Yb and Lu).

As described above, using a lubricant having a fine particle size is a simple and effective technique for obtaining a high dispersion state of carbon. Therefore, in the present invention, it is recommended that a lubricant particle size is 425 μm or less. Thus, the present invention provides a process for producing a rare earth sintered magnet characterized by comprising the steps of: obtaining a pulverized powder by pulverizing a raw material alloy to which has been added lubricant particles having a particle size of 425 μm or less; obtaining a compacted body by applying a magnetic field to the pulverized powder and then compacting; and sintering the compacted body.

In the present invention, the raw material alloy can be pulverized by charging the lubricant particles into a jet mill along with the raw material alloy. The mean particle size of the pulverized powder is preferably from 2.5 to 10 μm.

Lubricant particles having a particle size of 425 μm or less can be obtained by freezing a solid lubricant, and then pulverizing.

The particle size of the lubricant particles is preferably no greater than 1.5 times the particle size of the raw material alloy to be used for pulverization.

While the lubricant particles according to the present invention may be formed from a single substance, the lubricant particles can also be a mixture of a compound A represented by the general formula R₁—CONH₂ or R₁—CONH—R₃—HNCO—R₂, and a compound B represented by one selected from the group consisting of R₄—OCO—R₅, R₄—OH, and (R₄—COO)ₙM (wherein R_{1 to 4} denote CₙH₂ₙ₊₁ or CₙH₂ₙ₋₁; R₅ denotes H, CₙH₂ₙ₊₁ or CₙH₂ₙ₋₁; M denotes a metal; and “n” is an integer).

The fact that the particle size of the lubricant particles is no greater than 1.5 times the particle size of the raw material alloy to be used for pulverization is a factor which can independently constitute the present invention. Accordingly, the present invention provides a process for producing a rare earth sintered magnet characterized by comprising the steps of: obtaining lubricant particles having a particle size no greater than 1.5 times particle size of the raw material alloy by pulverizing the lubricant; obtaining a pulverized powder by pulverizing the raw material alloy added with the lubricant particles; obtaining a compacted body by applying a magnetic field to the pulverized powder and then compressing; and sintering the compacted body.

Further, the aspect wherein the lubricant particles are constituted from the above-described compound A and the above-described compound B can also independently constitute the present invention. Accordingly, the present invention provides a process for producing a rare earth sintered magnet characterized by comprising the steps of: obtaining a compacted body by applying a magnetic field to a raw material alloy powder to which a compound A represented by the general formula R₁—CONH₂ or R₁—CONH—R₃—HNCO—R₂, and a compound B represented by one selected from the group consisting of R₄—OCO—R₅, R₄—OH, and (R₄—COO)ₙM (wherein R_{1 to 4} denote CₙH₂ₙ₊₁ or CₙH₂ₙ₋₁; R₅ denotes H, CₙH₂ₙ₊₁ or CₙH₂ₙ₋₁; M denotes a metal; and “n” is an integer) have been added, and then compressing; and sintering the compacted body.

Here, in compound A, R₁ and R₂ are preferably represented by CₙH₂ₙ₊₁ (wherein “n” is from 7 to 21, inclusive thereof). Examples of compound A include at least one compound selected from the group consisting of stearic acid amide, ethylene bisstearic acid amide, behenic acid amide and caprylic acid amide.

Further, in compound B, R₄ is preferably represented by CₙH₂ₙ₊₁ (wherein “n” is 10 or more). Examples of compound B include at least one compound selected from the group consisting of stearic acid, glyceryl monostearate, zinc stearate and stearyl alcohol.

From the above, the lubricant according to the present invention can be a compound which comprises a fatty acid amide, and a fatty acid and/or stearyl alcohol.

Further, in the process for producing a rare earth sintered magnet according to the present invention, it is preferable to use a lubricant which comprises a compound D in which the compound A represented by the general formula R₁—CONH₂ or R₁—CONH—R₃—HNCO—R₂, and compound B represented by one selected from the group consisting of R₄—OCO—R₅, R₄—OH, and (R₄—COO)ₙM (wherein R_{1 to 4} denote CₙH₂ₙ₊₁ or CₙH₂ₙ₋₁; R₅ denotes H, CₙH₂ₙ₊₁ or CₙH₂ₙ₋₁; M denotes a metal; and “n” is an integer) are bound via a hydrocarbon. Compound D is a compound represented by R₆—CONH—R₇—OCO—R₆ (wherein R₆ and R₇ are hydrocarbons), and a specific example includes steroid ethylstearate. The R₆ of compound D may be represented by CₙH₂ₙ₊₁ (wherein “n” is from 12 to 17, inclusive thereof).

As explained above, according to the present invention a rare earth sintered magnet having a high dispersion state of carbon can be obtained. Therefore, by not increasing the use of a lubricant, which is the cause of carbon being present, orientation is high, so that a rare earth sintered magnet having a high residual magnetic flux density (Br) can be obtained. Based on this assumption, the rare earth sintered magnet according to the present invention can ensure coercive force (HcJ) and mechanical strength.

In production of the above rare earth sintered magnet according to the present invention, high orientation can be ensured by using a small amount of lubricant, through the use of a raw material alloy powder which is uniformly coated with carbon on its surface (i.e. the lubricant is more uniform). Further, because only a small amount of lubricant needs to be used, the drop in coercive force can be suppressed, and such process is effective in ensuring the mechanical strength. The use of a raw material alloy powder on which the lubricant is more uniformly coated is also effective in improving the strength of the compacted body.

### BRIEF DESCRIPTION OF THE DRAWINGS

FIG. 1 is a series of photographs illustrating the lubricant particles in Example 1, wherein FIG. 1A is a photograph of lubricant particles whose particle size is 425 μm or greater, and FIG. 1B is a photograph of lubricant particles whose particle size is less than 100 μm;

FIG. 2 is a table illustrating the lubricant particles, particle size of the milled powder and compacted body strength in Example 1;

FIG. 3 is a graph illustrating the relationship between lubricant additive amount and particle size of the milled powder when the particle size of the lubricant particles was varied in Example 1;

FIG. 4 is a graph illustrating the relationship between lubricant additive amount and compacted body strength when the particle size of the lubricant particles was varied in Example 1;

FIG. 5 is a graph illustrating the relationship between lubricant additive amount and sintered body carbon amount when the particle size of the lubricant particles was varied in Example 1;

FIG. 6 is a graph illustrating the relationship between lubricant additive amount and residual magnetic flux density (Br) when the particle size of the lubricant particles was varied in Example 1;

FIG. 7 is a graph illustrating the relationship between residual magnetic flux density (Br) and compacted body strength when the particle size of the lubricant particles was varied in Example 1;

FIG. 8 is a table illustrating the particle size of the lubricant particles and the milled powder in Example 2;

FIG. 9 is a table illustrating the particle size ratio (particle size of the lubricant/particle size of the pulverized powder) calculated from the particle size of the lubricant and the particle size of the pulverized powder in Example 2;

FIG. 10 is a graph illustrating the relationship between compacted body strength and residual magnetic flux density (Br) when the particle size of the lubricant was varied in relation to the pulverized powder with a particle size less than 100 μm in Example 2;

FIG. 11 is a graph illustrating the relationship between compacted body strength and residual magnetic flux density (Br) when the particle size of the lubricant was varied in relation to the pulverized powder with a particle size from 200 to 500 μm in Example 2;

FIG. 12 is a graph illustrating the relationship between compacted body strength and residual magnetic flux density (Br) when the particle size of the lubricant was varied in relation to the pulverized powder with a particle size from 500 to 800 μm in Example 2;

FIG. 13 is a graph illustrating the relationship between compacted body strength and residual magnetic flux density (Br) when the particle size of the lubricant was varied in relation to the pulverized powder with a particle size from 800 to 1,100 μm in Example 2;

FIG. 14 is a table illustrating the measured results of carbon amount (mass spectrometry), cv-value of carbon amount, coercive force (HcJ) and residual magnetic flux density (Br) in Example 3;

FIG. 15 is a graph illustrating the relationship between cv-value of carbon amount and flexural strength in Example 3;

FIG. 16 is a graph illustrating the relationship between carbon amount and flexural strength in Example 3;

FIG. 17 is a graph illustrating the relationship between carbon amount and coercive force (HcJ) in Example 3;

FIG. 18 is a graph illustrating the relationship between carbon amount and residual magnetic flux density (Br) in Example 3;

FIG. 19 is a table illustrating the measured results of carbon amount, Cmax/Cmin, coercive force (HcJ) and residual magnetic flux density (Br) in Example 4;

FIG. 20 is a table illustrating the measured results of the lubricant used in Example 5, and the residual magnetic flux density (Br) and compacted body strength;

FIG. 21 is a diagram illustrating the measuring process of flexural strength in Example 5;

FIG. 22 is a table illustrating the measured results of residual magnetic flux density (Br) and compacted body strength when the blending ratio of compound A and compound B were varied in Example 5;

FIG. 23 is a table illustrating the measured results of residual magnetic flux density (Br) and compacted body strength when the additive amounts of compound A and compound B were varied in Example 5;

FIG. 24 is a table illustrating the measured results of residual magnetic flux density (Br) and compacted body strength when the particle size of the lubricant was varied in Example 5; and

FIG. 25 is a table illustrating the measured results of residual magnetic flux density (Br) and compacted body strength when a compound D (steroid ethyl stearate) was used as the lubricant in Example 5.

### BEST MODE FOR CARRYING OUT THE INVENTION

The present invention can, for example, be applied to a rare earth sintered magnet, and in particular to an R—Fe—B system sintered magnet.

Such an R—Fe—B system sintered magnet comprises 25 to 37% by weight of a rare earth element (R). Here, “R” is a concept which includes Y. Accordingly, R according to the present invention is one or more elements selected from among Y, La, Ce, Pr, Nd, Sm, Eu, Gd, Tb, Dy, Ho, Er, Tm, Yb, and Lu. If the amount of R is less than 25% by weight, the formation of the R₂Fe₁₄B compound which serves as the main phase of the R—Fe—B system sintered magnet is insufficient, and α-Fe or the like having soft magnetism segregates, whereby the coercive force significantly drops. On the other hand, if R exceeds 37% by weight, the volume ratio of the R₂Fe₁₄B compound serving as the main phase drops, whereby the residual magnetic flux density drops. Further, R reacts with oxygen, whereby the oxygen amount increases, and as a consequence the R rich phase which is effective in coercive force generation decreases, causing a drop in coercive force. Therefore, the amount of R is set between 25% and 37% by weight. A preferable R amount is between 28% and 35% by weight, and amore preferable R amount is between 29% and 33% by weight.

This R—Fe—B system sintered magnet comprises 0.5% to 4.5% by weight of boron (B). If the amount of B is less than 0.5% by weight, a high coercive force cannot be attained. However, if the amount of B exceeds 4.5% by weight, the residual magnetic flux density is likely to drop. Accordingly, the upper limit of B is set at 4.5% by weight. A preferable amount of B is between 0.5% and 1.5% by weight, and more preferable is between 0.8% and 1.2% by weight.

This R—Fe—B system sintered magnet may comprise 2.0% by weight or less of Co (not including zero), preferably from 0.1 to 1.0% by weight, and more preferably from 0.3 to 0.7% by weight. While Co forms the same phase as Fe, it has an effect on improving Curie temperature and on improving the corrosion resistance of the grain boundary.

This R—Fe—B system sintered magnet may also comprise from 0.02 to 0.6% by weight of Al and/or Cu. By comprising Al and/or Cu in this range, it is possible to increase the coercive force, improve the corrosion resistance and improve the temperature properties of the obtained R—Fe—B system sintered magnet. When adding Al, a preferable Al amount is from 0.03 to 0.3% by weight, and more preferable is from 0.05 to 0.25% by weight. When adding Cu, a preferable Cu amount is 0.15% by weight or less (not including zero), and a more preferable Cu amount is from 0.03 to 0.12% by weight.

In addition this R—Fe—B system sintered magnet may also comprise other elements. For example, Zr, Ti, Bi, Sn, Ga, Nb, Ta, Si, V, Ag, Ge and the like can be incorporated as appropriate. On the other hand, it is preferable to decrease impurity elements, such as oxygen, nitrogen and the like, as much as possible. The amount of oxygen in particular, which harms magnetic properties, is preferably no greater than 5,000 ppm, and more preferably no greater than 3,000 ppm. This is because the rare earth oxide phase, which is a non-magnetic component, increases if the oxygen amount is large, which causes magnetic properties to drop.

The rare earth sintered magnet according to the present invention has a carbon amount as determined by mass spectrometry of between 500 and 1,500 ppm.

As described above, the carbon largely originates from the lubricant, and thus carbon amount is affected by the additive amount of lubricant. From this perspective, if the carbon amount is less than 500 ppm, this suggests that the additive amount of lubricant is insufficient, whereby it is difficult for the desired residual magnetic flux density (Br) to be conferred to the rare earth sintered magnet. On the other hand, if the carbon amount is more than 1,500 ppm, coercive force (HcJ) drops. Therefore, in the present invention the carbon amount is set between 500 and 1,500 ppm. A preferable carbon amount is between 700 and 1,300 ppm, and an even more preferable carbon amount is between 800 and 1,200 ppm.

In addition, the rare earth sintered magnet according to the present invention has a cv-value of carbon amount at a rupture plane thereof of no greater than 200. The cv-value of carbon amount indicates the dispersion state of carbon in the sintered body. The smaller the cv-value, the more uniformly the carbon is dispersed in the sintered body. In the present invention, by determining the dispersion state of carbon, it is possible to ensure that a rare earth sintered magnet can be obtained having high coercive force and mechanical strength. In the present invention, the cv-value of carbon amount can be set to be no greater than 150, or no greater than 130.

The present invention is not limited to the above-described R—Fe—B system sintered magnet, and can also be applied to some other rare earth sintered magnet. For example, the present invention can also be applied to an R—Co system sintered magnet.

An R—Co system sintered magnet comprises R, one or more elements selected from among Fe, Ni, Mn and Cr, and Co. In this case, it is preferable to further comprise Cu or one or more elements selected from among Nb, Zr, Ta, Hf, Ti and V. It is especially preferable to comprise Cu and one or more elements selected from among Nb, Zr, Ta, Hf, Ti and V. Among these, an intermetallic compound consisting of Sm and Co is preferable in particular, which has preferably a Sm₂CO₁₇ intermetallic compound as the main phase and a minor phase based on a SmCo₅ system on the grain boundary. While the specific composition can be appropriately selected depending on the production process or the required magnetic properties, a preferable example could be, for example: about 20 to 30% by weight, and especially 22 to 28% by weight, of R; about 1 to 35% by weight of one or more elements selected from among Fe, Ni, Mn and Cr; 0 to 6% by weight, and especially about 0.5 to 4% by weight, of one or more elements selected from among Nb, Zr, Ta, Hf, Ti and V; 0 to 10% by weight, and especially about 1 to 10% by weight, of Cu; and a balance of Co.

While an R—Fe—B system sintered magnet and an R—Co system sintered magnet were explained above, this does not stop the present invention from being applied to other rare earth sintered magnets.

The production process of the rare earth sintered magnet according to the present invention will now be explained in order of its steps. It should be noted that among the following steps, the step relating to addition of the lubricant is the characteristic portion for obtaining the rare earth sintered magnet according to the present invention.

The raw material alloy can be produced by strip casting or some other well-known dissolution process in a vacuum or an inert gas atmosphere, preferably an Ar atmosphere. In strip casting, a raw material metal is dissolved in a non-oxidative atmosphere, such as an argon atmosphere, and the resulting molten metal is squirted onto the surface of a rotating roll. The molten metal is rapidly cooled by the roll, and rapidly cools and solidifies into a thin plate or thin flakes (scale) form. This rapidly cooled solidified alloy possesses a uniform microstructure whose grain size is between 1 and 50 μm. The raw material alloy is not limited to being produced by strip casting, and can be obtained by dissolution processes such as high-frequency induction dissolution or the like. To prevent post-dissolution segregation, the molten metal can be solidified by, for example, pouring at an incline onto a water-cooled copper plate. In addition, an alloy obtained by a reduction diffusion process can also be used as the raw material alloy.

In the case of obtaining an R—Fe—B system sintered magnet, a so-called mixing process can be applied to the present invention, which uses an alloy (low R alloy) whose main constituent is an R₂Fe₁₄B compound and an alloy (high R alloy) which comprises a larger amount of R than the low R alloy.

The raw material alloy is subjected to a pulverizing step. When employing a mixing process, the low R alloy and high R alloy may be pulverized separately or together. The pulverizing step comprises a pulverizing step and a milling step.

First, in the pulverizing step, a raw material alloy is pulverized to a particle size of approximately several hundreds of μm, to thereby obtain a pulverized powder (raw material alloy). In the present invention, for the sake of convenience, the state up until the pulverized state is referred to as “raw material alloy”, and the state after the milling is sometimes referred to as “raw material alloy powder”. The pulverizing is preferably carried out in an inert gas atmosphere, using a stamp mill, a jaw crusher, a Brown mill or the like. Prior to the pulverizing, it is effective to carry out pulverizing by occluding hydrogen into the raw material alloy and then letting the hydrogen be released from the raw material alloy. The hydrogen release treatment is conducted for the purpose of decreasing the amount of hydrogen which acts as impurities in the rare earth sintered magnet. The hydrogen occlusion is carried out at from room temperature to 200° C. for 30 minutes or more, and preferably for 1 hour or more. The hydrogen release treatment may be carried out at from 350 to 650° C. in a vacuum or under an argon gas flow. It is noted that the hydrogen occlusion treatment and the hydrogen release treatment are not essential. Mechanical pulverizing can also be omitted by conducting this hydrogen pulverizing as the pulverizing.

After the pulverizing step, the operation moves on to the milling step.

The lubricant is added at this stage in order to improve the pulverizing properties in the milling step and improve the orientation by the compacting in a magnetic field. Examples of the lubricant include fatty acids or fatty acid derivatives, such as the stearic acid-based or oleic acid-based zinc stearate, calcium stearate, stearate acid amide and oleic acid amide.

The lubricant preferably comprises a compound A represented by the general formula R₁—CONH₂ or R₁—CONH—R₃—HNCO—R₂, and a compound B (wherein R_{1 to 4} denote CₙH₂ₙ₊₁ or CₙH₂ₙ₋₁ and R₅ is represented by H, CₙH₂ₙ₊₁ or CₙH₂ₙ₋₁) represented by one selected from the group consisting of R₄—OCO—R₅, R₄—OH, and (R₄—COO)ₙM (wherein M denotes a metal and “n” is an integer).

Compound A is a compound having an amide group such as a fatty acid amide or a compound having an amide bond such as a fatty acid bisamide. R₁ and R₂ are preferably straight chain saturated hydrocarbons having from 7 to 21 carbons. Specific examples of such a compound A include stearic acid amide (C₁₇H₃₅—CONH₂), ethylene bisstearic acid amide (C₁₇H₃₅—CONH— (CH₂)₂—NHCO—C₁₇H₃₅), behenic acid amide (C₂₁H₄₃—CONH₂) and caprylic acid amide (C₇H₁₅—CONH₂). Among these, stearic acid amide is especially preferable. In the present invention, while a single kind of compound may be used as the compound A, a plurality of compounds can also be used together.

Compound B is, for example, a fatty acid compound or an alcohol. Specific examples include higher fatty acids, higher fatty acid esters, higher fatty acid metal salts, higher alcohols and the like, each having 10 or more carbons. Among these, compound B is preferably a compound whose R₄ is a hydrocarbon having 17 or 18 carbons. Specific examples include stearic acid (C₁₇H₃₅—COOH), glyceryl monostearate (C₁₇H₃₅—COO—C₃H₇O₂), zinc stearate (C₁₇H₃₅—COO)⁻₂Zn²⁺) and stearyl alcohol (C₁₈H₃₇—O—H). Among these, stearic acid and glyceryl monostearate are more preferable, and stearic acid is especially preferable. In the present invention, while a single kind of compound may be used as the compound B, a plurality of compounds can also be used together.

The mixing ratio between compound A and compound B can be adjusted as appropriate, although to increase the strength of the below-mentioned compacted body and increase the magnetic properties of the sintered magnet, it is preferable to mix so that the ratio is from 9:1 to 1:2 on a weight basis. Even more preferable is from 9:1 to 1:1, and especially preferably is roughly 1:1. If compound A and compound B are mixed at about 1:1, the additive amount of lubricant is preferably set at a total of from 0.075 to 0.1% by weight.

Further, in addition to this, a compound D in which the compound A and compound B are bound via a hydrocarbon may be used as the lubricant. Examples thereof include compounds having an amide bond and an ester bond, such as R₆—CONH—R₇—OCO—R₆ (wherein R₆ and R₇ are hydrocarbons). Specifically, R₆ is a compound represented by CₙH₂ₙ₊₁ (wherein “n” is from 12 to 17, inclusive thereof). Examples thereof include steroid ethyl stearate (C₁₇H₃₅CONH(CH₂)₂OCOC₁₇H₃₅) consisting of stearic acid wherein the carbon number of R is 17.

If the particle size of the pulverized powder is from 100 to 1,000 μm, it is desirable to use a lubricant whose particle size is 425 μm or less, preferably 400 μm or less, more preferably 300 μm or less and even more preferably 100 μm or less. By using a lubricant having such a particle size, a raw material alloy powder can be obtained in which carbon is uniformly coated on the surface (i.e. the lubricant is more uniformly coated). Further, by using such a raw material alloy powder, a rare earth sintered magnet can be obtained whose cv-value of carbon amount is low, or in other words, whose dispersion state of carbon is good.

However, if the particle size of the lubricant is too small, the below problems give cause for concern. Namely, if the milling is conducted using a jet mill, the lubricant is discharged out of the system together with the air flow, thus necessitating the addition of a large amount of lubricant in order to achieve the desired effects. Moreover, clogging of the filter in the jet mill is promoted, which is a hindrance to performing a stable pulverizing operation. Further, to obtain a lubricant having a small particle size, considerable costs are required. Taking the above points into consideration, the particle size of the lubricant is preferably no less than 5 μm.

To make the lubricant have the above-described particle size, it is preferable to crush the lubricant and then grade using a sieve or the like. In the pulverizing of the lubricant, it is preferable to freeze the lubricant with, for example, liquid nitrogen, and then crush the frozen lubricant using a mill or the like.

Although from the perspective of improving pulverizing properties and orientation, the additive amount of lubricant is preferably as much as possible, from the perspective of coercive force, compacted body strength and sintered body strength, the additive amount is preferably as small as possible. Therefore, the additive amount of lubricant is preferably set at between 0.01 and 1.0% by weight, more preferably at between 0.02 and 0.5% by weight, and even more preferably at between 0.05 and 0.1% by weight. The mixing of the lubricant may be carried out for between about 5 and 30 minutes using, for example, a Nauta mixer.

It is preferable to use as the lubricant a substance (lubricant particles) whose particle size has been made smaller by pulverizing the lubricant beforehand. However, it is also preferable to give consideration to the relationship with the particle size of the pulverized powder (raw material alloy). Specifically, the particle size of the lubricant particles is preferably no greater than 1.5 times the particle size of the pulverized powder (particle size ratio (particle size of the lubricant/particle size of the pulverized powder) of 1.5). More preferably, the particle size of the lubricant particles is preferably no greater than equal to the particle size of the pulverized powder (particle size ratio of 1.0), and still more preferably is no greater than 0.7 times the particle size of the pulverized powder (particle size ratio of 0.7). For example, if the particle size of the pulverized powder is about from 100 to 1,000 μm, the particle size of the lubricant is from 150 μm or less to 1,500 μm or less, preferably from 100 μm or less to 1,000 μm or less, and more preferably from 70 μm or less to 700 μm or less.

The lubricant particles can be formed from any kind of process. For example, the lubricant particles having a desired particle size can be obtained by spray drying or the like. Alternatively, the lubricant can be solidified by freezing with liquid nitrogen, and then pulverizing the lubricant in the frozen state with a mill or the like, to thereby obtain lubricant particles having a desired particle size. In addition, the lubricant particles may be classified using a sieve or the like after pulverizing the lubricant to achieve the above-described particle size.

A milled powder (raw material alloy powder, pulverized powder) having a mean particle size of from 2.5 to 10 μm, and preferably from 3 to 5 μm, is then obtained by milling the pulverized powder. In the milling a jet mill is mainly employed. The jet mill generates a high-speed gas flow by releasing a high-pressure inert gas from a narrow nozzle. The pulverized powder is accelerated by this high-speed gas flow, causing pulverized powder particles to collide with each other, a target, or the container wall, whereby the powder is pulverized. During the milling process with this jet mill, the milled powder is repeatedly made to collide with the lubricant, so that its surface becomes coated by the lubricant. The lubricant is consumed in this way during the milling process.

In the case of using a mixing process, the timing for mixing the two kinds of alloy is not limited. However, if the low R alloy and the high R alloy are pulverized separately in the milling process, the milled low R alloy powder and the milled high R alloy powder are mixed in a nitrogen gas atmosphere. The mixing ratio of the low R alloy powder and the high R alloy powder may be set approximately between 80:20 and 97:3 by weight ratio. The mixing ratio for when the low R alloy is pulverized together with the high R alloy is the same.

The raw material alloy powder for a rare earth sintered magnet according to the present invention which has undergone milling has a carbon amount as determined by mass spectrometry of 1,200 ppm or less. As described above, the carbon originates from the lubricant, and thus the carbon amount reflects the amount of lubricant that is added. If the carbon amount is more than 1,200 ppm, this amount has become too large even if the coated state of the lubricant is uniform, whereby the drop in coercive force cannot be ignored. Therefore, in the present invention the carbon amount is set at 1,200 ppm or less. A preferable carbon amount is 1,000 ppm or less, and a more preferable carbon amount is 900 ppm or less.

The raw material alloy powder for a rare earth sintered magnet according to the present invention has a Cmax/Cmin of 15 or less (wherein Cmax and Cmin respectively represent a maximum value and a minimum value of X-ray intensity of characteristic X-rays of carbon as determined by EPMA). Cmax/Cmin indicates the variation of the carbon in the respective particles which constitute the raw material alloy powder. The smaller this value is, the more uniform the carbon concentration on the raw material alloy powder surface, or in other words, the more uniformly that the lubricant is coated. If Cmax/Cmin exceeds 15, there is a difference in the amount of lubricant coated on each particle constituting raw material alloy powder, so that the desired effects on orientation of the lubricant cannot be achieved unless the additive amount is increased. A preferable Cmax/Cmin is 10 or less, and more preferable is 5 or less. Cmax/Cmin in the present invention is determined from the maximum and minimum values found from the X-ray intensity of characteristic X-rays of carbon for 50 particles arbitrarily selected from the raw material alloy powder (specifically, the powder which has been milled). This is also the same for the below-described Examples.

In the raw material alloy powder for a rare earth sintered magnet according to the present invention, as described above the reason why carbon is detected is that a lubricant comprising an organic compound is coated on the surface of the raw material alloy powder. As is described below, this lubricant is added during the milling as a solid lubricant in particle form, and is consumed by the repeated collisions with the raw material alloy powder during the milling process, thereby being coated onto the surface of the raw material alloy powder. The fact that Cmax/Cmin is 15 or less, and more preferably 10 or less or 5 or less, indicates that the lubricant is uniformly coated on the surface of the raw material alloy powder. Such a uniform lubricant coating can be achieved by adding a particulate solid lubricant with a smaller particle size.

In the present invention, the use of other techniques for obtaining a fine lubricant is not ruled out. For example, as disclosed in Patent Document 2, techniques which can be employed include making a lubricant which is in a liquefied state finer, using a fine lubricant produced by a gas phase process, or mixing the lubricant at a temperature, for example, close to the melting point of the lubricant (melting point −10° C.).

Next, a milled powder which has been mixed with a lubricant is filled into a mold cavity, and subjected to compacting in a magnetic field.

The pressure during the compacting in a magnetic field can be set in the range of from 30 to 300 MPa. The pressure may be constant from start to finish, or may be gradually increased or decreased, or may vary irregularly. While orientation improves the lower the pressure is, if the pressure is too low the strength of the compacted body is insufficient, and problems also arise with handling, so that the pressure is selected from within the above range with this in mind. The final relative density of the compacted body obtained by compacting in a magnetic field is, usually, from 50 to 60%.

The applied magnetic field may be set between 12 and 20 kOe. Further, the applied magnetic field is not limited to a magnetostatic field, and may be a pulsed magnetic field, or a combination of a magnetostatic field and a pulsed magnetic field.

The compacted body obtained by compacting in a magnetic field is subjected to a heat treatment for removing the lubricant. This is to prevent a drop in magnetic properties as a result of residual carbon. The treatment is preferably carried out in a hydrogen atmosphere, and is also preferably carried out during the temperature raising step in the subsequent sintering. However, even if subjected to this lubricant removal treatment, on an industrial production scale it is difficult to completely remove the carbon, whereby carbon remains in the rare earth sintered magnet as rare earth carbides.

After the lubricant removal treatment, the compacted body is sintered in a vacuum or inert gas atmosphere. Although the sintering temperature needs to be adjusted depending on various conditions, such as composition, pulverizing process, differences in mean particle size and particle size distribution and the like, the sintering may be carried out in a vacuum at from 1,000 to 1,200° C. for between 1 and 10 hours.

After sintering, the obtained sintered body may be subjected to an aging treatment. This step is important for controlling coercive force. If the aging treatment is carried out with two stages, it is effective to hold for a fixed time at from 750 to 1,000° C., and from 500 to 700° C. Conducting the 750 to 1,000° C. heat treatment after the sintering is particularly effective in a mixing method because coercive force increases. Further, since coercive force substantially increases from the 500 to 700° C. heat treatment, if carrying out the aging treatment in a single stage, subjecting to the 500 to 700° C. heat treatment is better.

### EXAMPLE 1

The influence of particle size of the lubricant added during the milling step was investigated. The results will be illustrated as Example 1.

The composition of the raw material alloy was 24.5% by weight of Nd, 6.0% by weight of Pr, 1.8% by weight of Dy, 0.5% by weight of Co, 0.2% by weight of Al, 0.07% by weight of Cu, 1.0% by weight of B and the balance being Fe. Metals or alloys which were to become the raw material were blended together so as to form the above-described composition, and the resultant raw material was melted and cast into a raw material alloy thin plate by strip casting. The obtained raw material alloy thin plate underwent hydrogen-pulverizing, and the resultant product was subjected to mechanical pulverizing using a Brown mill, whereby a pulverized powder was obtained.

This pulverized powder was charged with oleic amide as a lubricant. Subsequently, a milled powder was obtained using a jet mill.

As the lubricant added during the milling, a plurality of kinds having a differing particle size were prepared. Using commercially available oleic amide (Product name: “Neutron”, manufactured by Nippon Fine Chemical Co., Ltd.) as a lubricant, this lubricant was frozen with liquid nitrogen, and then pulverized by a mill. The pulverized lubricant was classified using a sieve, to obtain the below 7 kinds of lubricant.

(1) particle size of less than 2 μm

(2) particle size of less than 45 μm

(3) particle size of less than 100 μm

(4) particle size of 100 μm or more to less than 150 μm

(5) particle size of 150 μm or more to less than 300 μm

(6) particle size of 300 μm or more to less than 425 μm

(7) particle size of 425 μm or more

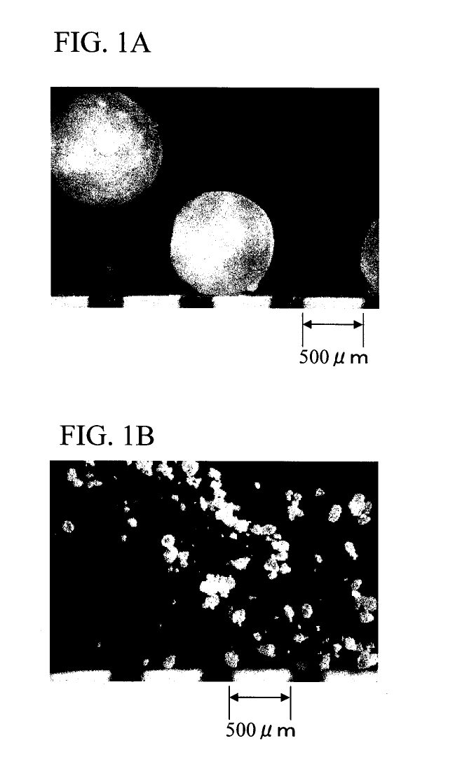

A photograph of the lubricant classified in this manner is illustrated in FIG. 1. FIG. 1A is a photograph wherein the particle size of the lubricant is 425 μm or more, and FIG. 1B is a photograph wherein the particle size of the lubricant is less than 100 μm.

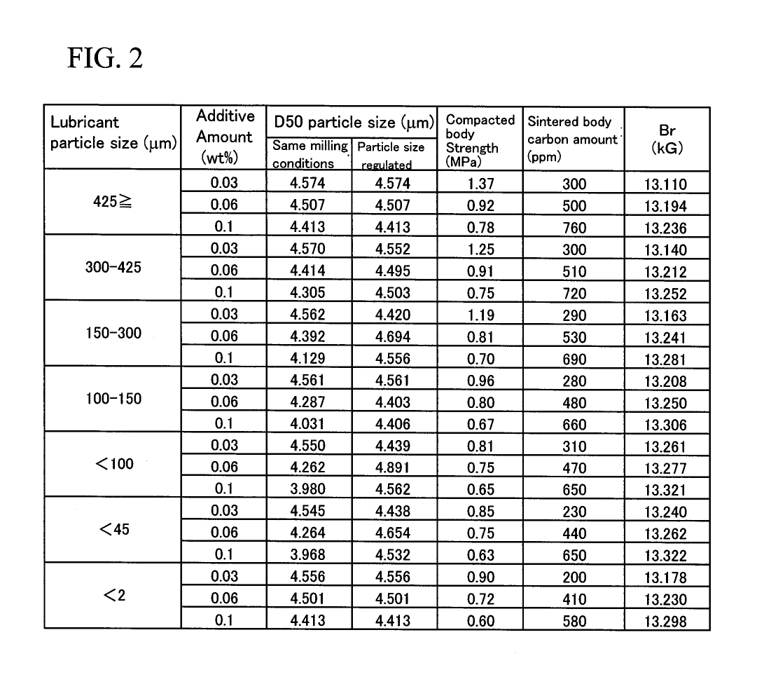

Each lubricant produced in this manner was charged into a pulverized powder, and the resultant mixture was pulverized under the same milling conditions (pulverizing gas pressure 7 kg/cm², feeding rate of 40 g/min) using the jet mill. The particle size of the obtained milled powder (wherein D50 is the particle size at which the cumulative volume ratio reaches 50% (hereinafter the same)) is illustrated in the “Same milling conditions” column of FIG. 2. Here, the additive amounts of lubricant into the pulverized powder were three levels: 0.03, 0.06 and 0.1% by weight.

As illustrated in the “Particle size regulated” column of FIG. 2, for each of the lubricants (1) to (7) a milled powder was also prepared by regulating the milling conditions so that the particle size of the milled powder obtained by milling was 4.40 μm or more to less than 4.90 μm.

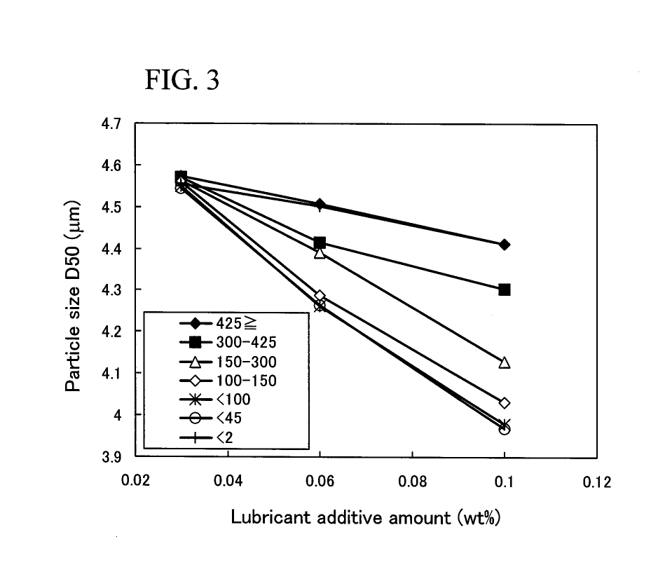

FIG. 3 illustrates the relationship between the additive amount of lubricant and particle size (D50; same milling conditions) of the milled powder. As illustrated in FIG. 3, until a particle size of up to 100 μm, the particle size of the milled powder tends to be smaller, the finer the particle size of the lubricant is. This means that milling efficiency has increased. In other words, the lubricant added during the milling is consumed by the repeated collisions with the raw material alloy powder during the milling process, and thereby coated onto the surface of the raw material alloy powder. However, the finer the particle size of the lubricant, the better the dispersion state of the lubricant is in the milled powder. Nevertheless, if the particle size of the lubricant is less than 45 μm, the particle size of the milled powder is about the same level as when the particle size of the lubricant is less than 100 μm. Moreover, if the particle size of the lubricant is less than 2 μm, the milling effects cannot be sufficiently achieved, as the lubricant is too fine and thus discharged out of the system. In this case, the particle size of the milled powder is no better than that in the case where the particle size of the lubricant is less than 425 μm.

Next, the milled powders produced by regulating the milling conditions were compacted in a magnetic field. Specifically, they were compacted in a 15 kOe magnetic field at a pressure of 137 MPa, whereby a 20 mm×18 mm×6 mm compacted body was obtained. The magnetic field direction was perpendicular to the press direction.

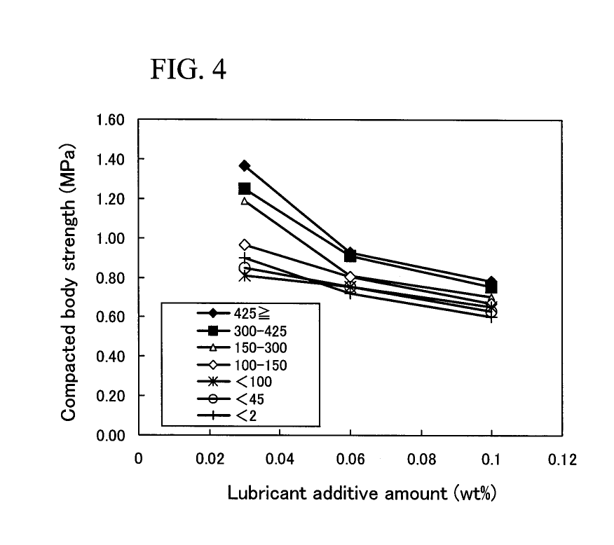

The strength of the obtained compacted body was measured by a three-point bending test. Here, since compacted body strength is dependent on particle size, a compacted body was formed using milled powders whose D50 were all between 4.40 μm or more and 4.90 μm or less, and the strength of this compacted body was measured. The specific measuring conditions are described in the below-described Example 5. These results are illustrated in FIG. 2, and the relationship between the lubricant additive amount and compacted body strength is illustrated in FIG. 4.

As illustrated in FIG. 4, the finer the particle size of the lubricant, and, the greater the amount of charged lubricant, the more the compacted body strength dropped. Since a lubricant has lubricating properties, the lubricant has the characteristic of lowering the compacted body strength, whereby from such results it was confirmed that if the dispersion of the lubricant is improved, the strength is lowered.

In addition, sintered bodies were produced by sintering a compacted body formed in the same manner as described above at 1,030° C. for 4 hours.

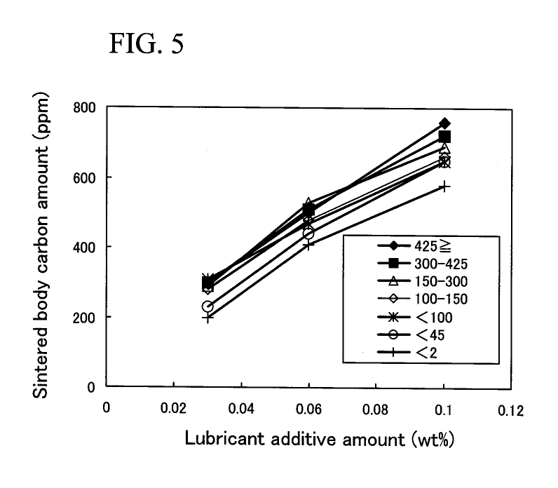

The carbon amount of the sintered bodies was measured. FIG. 2 illustrates those results, and FIG. 5 illustrates the relationship between the additive amount of lubricant and the carbon amount. As illustrated in FIG. 5, the amount of residual carbon tends to be less the finer the particle size of the lubricant is. This tendency is especially noticeable if the particle size of the lubricant is less than 2 μm.

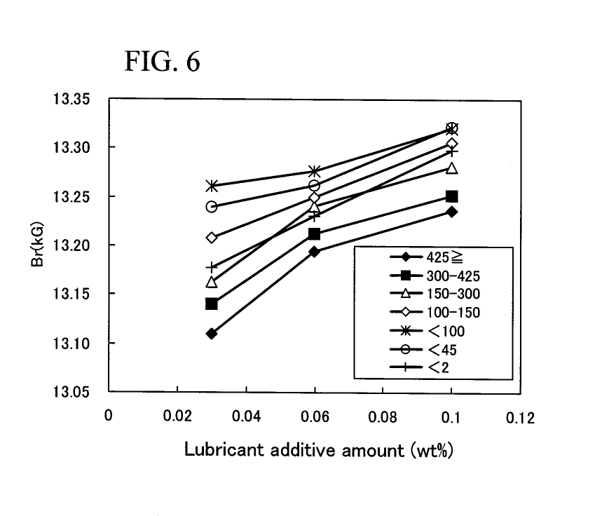

The obtained sintered bodies were subjected to an aging treatment (conditions: 900° C.×1 hour, 540° C.×1 hour), and after sintered magnets had been obtained, the residual magnetic flux density (Br) of the sintered magnets was measured using a B—H tracer. FIG. 2 illustrates those results, and FIG. 6 illustrates the relationship between the additive amount of lubricant and residual magnetic flux density (Br). As illustrated in FIG. 6, the finer the particle size of the lubricant, and, the greater the additive amount of lubricant, the more residual magnetic flux density (Br) improved. This is due to the dispersion of the lubricant getting better the finer the particle size of the lubricant, and, the greater the additive amount of lubricant, whereby magnetic orientation becomes easier. However, these effects decreased once the particle size of the lubricant was less than 2 μm. Therefore, the particle size of the lubricant is preferably set at 5 μm or more.

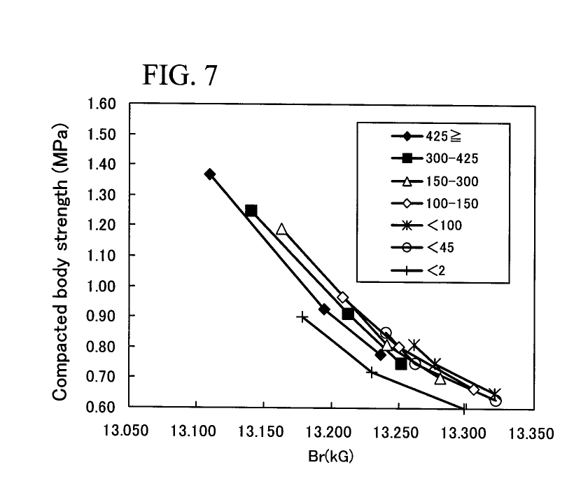

FIG. 7 illustrates the relationship between the compacted body strength of FIG. 4 and the residual magnetic flux density (Br) of FIG. 6.

As illustrated in FIG. 7, it was confirmed that a lubricant with a finer particle size provided a combination of a higher residual magnetic flux density (Br) and a higher compacted body strength. That is, when it is desired to satisfy residual magnetic flux density (Br), it became clear that if a finer lubricant is used the additive amount can be decreased, so that as a result a higher compacted body strength can be attained.

### EXAMPLE 2

Next, the results of an investigation into the particle size of the raw material alloy (pulverized powder) which was subjected to milling and the particle size of the lubricant is illustrated as Example 2.

The composition of the raw material alloy was 24.5% by weight of Pr, 6.0% by weight of Dy, 1.8% by weight of Co, 0.5% by weight of Al, 0.2% by weight of Cu, 0.07% by weight of B, and the balance being Fe, and these materials were melted and cast into a raw material alloy thin plate by strip casting. The obtained raw material alloy thin plate underwent hydrogen-pulverizing, and the resultant product was subjected to mechanical pulverizing using a Brown mill, whereby a pulverized powder was obtained. The pulverized powder was formed as a flat sheet, had a thickness of about 100 to 300 μm and a size (length) of about 100 to 1,000 μm. The pulverized powder was classified using a sieve into sizes of 200 μm or more to less than 500 μm and 500 μm or more to less than 800 μm.

Oleic amide serving as the lubricant was frozen with liquid nitrogen, and then pulverized by a mill. The obtained lubricant (lubricant particles) was classified using a sieve.

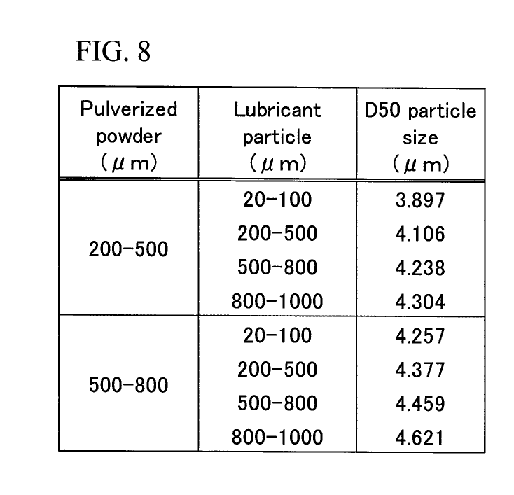

The classified pulverized powder and the classified lubricant were both milled in the combinations illustrated in FIG. 8. The additive amount of the lubricant was respectively 0.1% by weight. Using a jet mill, the milling was conducted in a high-pressure nitrogen atmosphere at a milling gas pressure of 7 kg/cm² and a feeding rate of 40 g/min, to thereby obtain a milled powder. The particle size distribution of the obtained milled powder was determined as the measured particle size (D50). The results are illustrated in FIG. 8.

As can be seen from FIG. 8, the finer the particle size of the lubricant, the greater the improvement in milling efficiency, whereby the particle size (D50) of the milled powder decreased. From this it is thought that the dispersibility for a lubricant having a fine particle size improved, and as a result, milling efficiency improved.

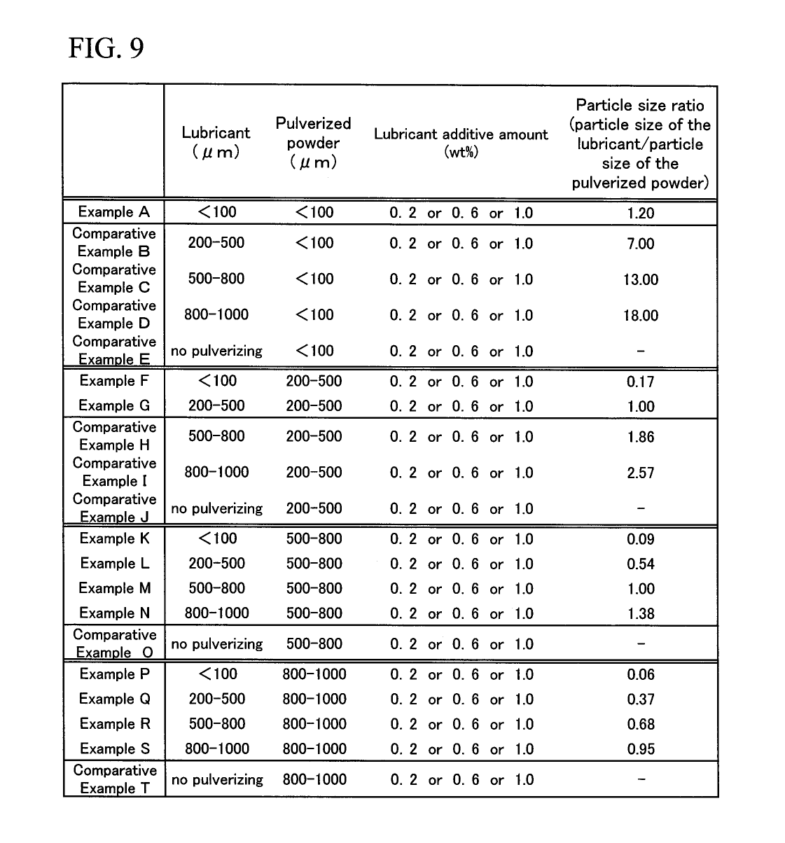

Next, in the same manner as above, prepared were a lubricant classified into particle size of 20 μm or more to less than 100 μm, particle size of 200 μm or more to less than 500 μm, particle size of 500 μm or more to less than 800 μm, and particle size of 800 μm or more to less than 1,000 μm, and a pulverized powder classified into particle size of less than 100 μm, particle size of 200 μm or more to less than 500 μm, particle size of 500 μm or more to less than 800 μm, and particle size of 800 μm or more to less than 1,100 μm. These classified powders were both then milled in the combinations illustrated in FIG. 9. The additive amount of the lubricant was respectively 0.02% by weight, 0.06% by weight or 0.1% by weight. Further, since the milling efficiency of a milled powder varies depending on the particle size and additive amount of the lubricant, when conducting the milling treatment in the same manner as described above, the milling time was adjusted for both of these factors, so that the particle size (D50) of the ultimately obtained milled powder was regulated to 4.40 μm<D50<4.60 μm. It is noted that the milling of the pulverized powders which had a greater particle size tended to take more time. The ratio between the particle size of the lubricant obtained in the Example and the particle size of the pulverized powder (particle size of the lubricant/particle size of the pulverized powder) is illustrated in FIG. 9. In the calculation of particle size ratio, the respective particle sizes were taken as the middle value in the particle size range according to classifying. For example, for the 20 to 100 μm range, 60 μm was taken as the particle size, and for the 200 to 500 μm range, 350 μm was taken as the particle size. In addition, as Comparative Examples, milled powders were prepared in the same manner as in the present Example, except that a non-pulverized lubricant and a non-classified pulverized powder were used.

The resulting milled powders were compacted in a respective magnetic field. Specifically, they were compacted in a 15 kOe magnetic field at a pressure of 137 MPa, whereby 20 mm×18 mm×6 mm compacted bodies were obtained. The magnetic field direction was perpendicular to the press direction.

The strength of the obtained compacted bodies was measured by a three-point bending test. The compacted body strength depends on the particle size. However, in the present Example, the particle size of the milled powders was, as described above, within a fixed range (4.40 μm<D50<4.60 μm), and hence the compacted body strengths were easy to compare. The specific measuring conditions for compacted body strength are described in Example 5 described later.

The obtained compacted bodies were sintered at 1,030° C. for 4 hours, to thereby yield sintered bodies. These sintered bodies were subjected to an aging treatment (conditions: 900° C.×1 hour, 540° C.×1 hour), and after sintered magnets had been obtained, the residual magnetic flux density (Br) of these sintered magnets was measured using a B—H tracer.

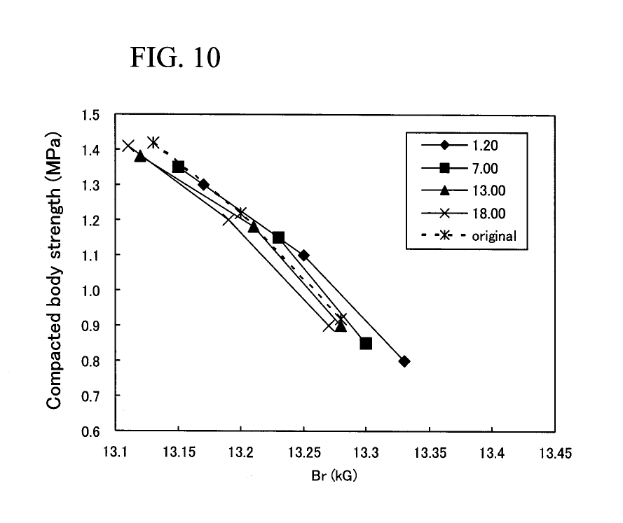

FIG. 10 illustrates as a graph the relationship between compacted body strength and residual magnetic flux density (Br) for Example A (particle size ratio of 1.20) illustrated in FIG. 9 whose particle size of the pulverized powder was less than 100 μm, and Comparative Examples B to E (particle size ratios of 7.00, 13.00 and 18.00; no pulverizing).

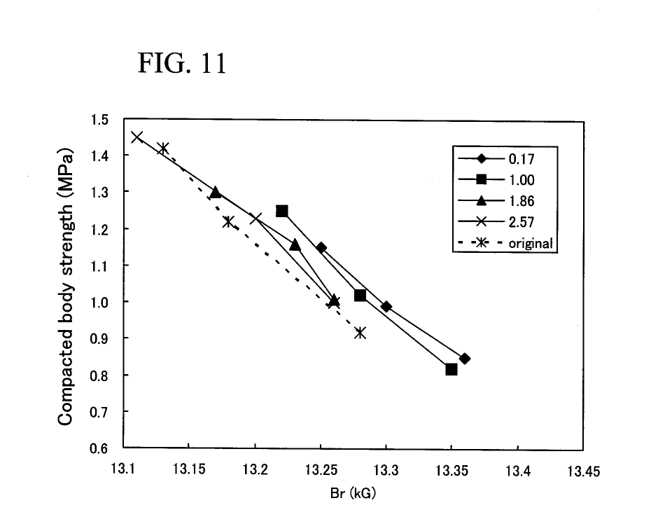

FIG. 11 illustrates as a graph the relationship between compacted body strength and residual magnetic flux density (Br) for Examples F and G (particle size ratios of 0.17, 1.00) illustrated in FIG. 9 whose particle size of the pulverized powder was between 200 and 500 μm, and Comparative Example H to J (particle size ratios of 1.86 and 2.57; no pulverizing).

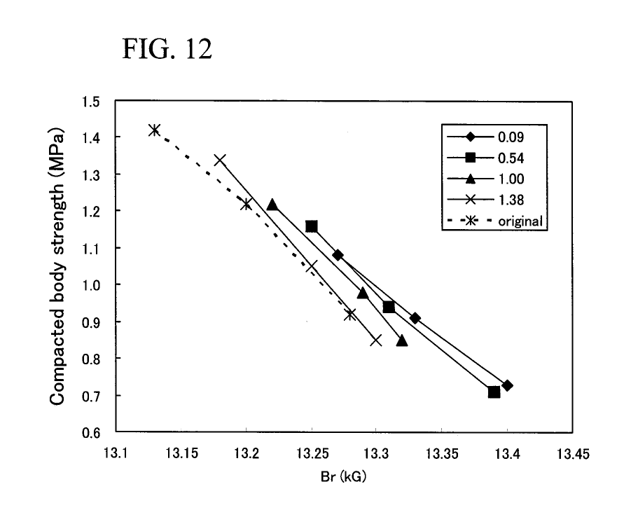

FIG. 12 illustrates as a graph the relationship between compacted body strength and residual magnetic flux density (Br) for Examples K to N (particle size ratios of 0.09, 0.54, 1.00 and 1.38) illustrated in FIG. 9 whose particle size of the pulverized powder was between 500 and 800 μm, and Comparative Example O (no pulverizing).

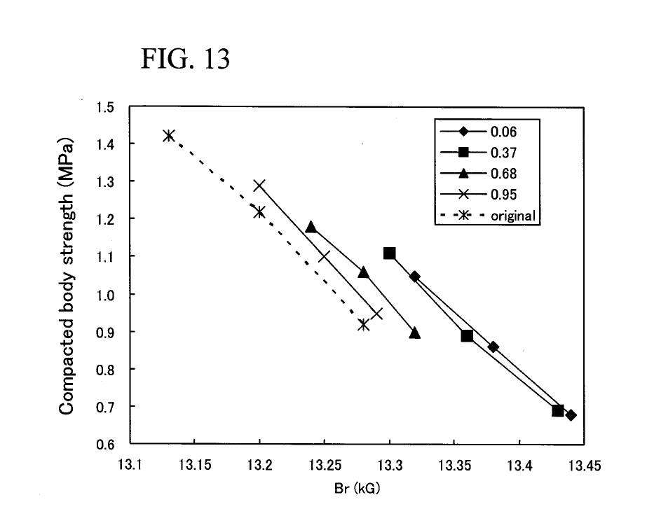

FIG. 13 illustrates as a graph the relationship between compacted body strength and residual magnetic flux density (Br) for Examples P to S (particle size ratios of 0.06, 0.37, 0.68 and 0.95) illustrated in FIG. 9 whose particle size of the pulverized powder was between 800 and 1,100 μm, and Comparative Example T (no pulverizing).

FIGS. 10 to 13 illustrate the results for additive amounts of lubricant, in order, of 0.02% by weight, 0.06% by weight and 0.1% by weight heading from a low residual magnetic flux density (Br) to a high residual magnetic flux density (Br). The captions in these figures contain numerals which represent the particle size ratio (particle size of the lubricant/particle size of the pulverized powder). The term “original” contained in the figures denotes the results of cases where a non-pulverized lubricant and a non-classified pulverized powder were used.

As can be seen from FIGS. 10 to 13, if the additive amount is varied without varying the particle size of the pulverized powder, dispersion of the lubricant improves for greater additive amounts of lubricant, whereby orientation of the particles is easier, thereby resulting in residual magnetic flux density (Br) increasing. In this case, since the bonds between particles are lower, the compacted body strength tends to decrease. As can also be seen by comparing each of the FIGS. 10 to 13, dispersion of the lubricant improves the finer the particle size of the lubricant is, whereby magnetic orientation is easier and residual magnetic flux density (Br) increases.

As can be further seen by comparing FIGS. 10 to 13, residual magnetic flux density (Br) tends to increase the greater the particle size of the pulverized powder. This is especially noticeable in the examples in which the particle size ratio was 1.5 or less. This trend is thought to be as a consequence of the milling time to align the particle size of the milled powder taking more time, whereby as a result, the lubricant becomes better dispersed.

However, as the sintered magnet, it is preferable for the compacted body strength to be high in the production process. In addition, as the sintered magnet, it is preferable for the residual magnetic flux density (Br) to be high. Therefore, in the respective graphs of FIGS. 10 to 13, the higher on the right side the plots are, the better performance the sintered magnet has. As illustrated in FIGS. 10 to 13, it can be seen that the finer the particle size of the used lubricant, and the smaller the particle size ratio of the sintered magnet, the higher the performance is. Further, as can be seen from the Comparative Examples of FIGS. 10 to 13, when using a lubricant having a particle size greater than the particle size of the pulverized powder, and whose particle size ratio is large, the results did not substantially differ from when a non-pulverized lubricant and a non-classified pulverized powder (denoted by the term “original” in the Figures) were used.

As described above, as a lubricant having a fine particle size, by regulating the particle size of the lubricant, especially so that the particle size ratio is 1.5 or less, superior compacted body strength and residual magnetic flux density (Br) can be achieved. Further, if the particle size ratio is 1.0 or less, and especially if 0.7 or less, the residual magnetic flux density (Br) and compacted body strength were remarkably improved. In contrast, if both the particle size and the particle size ratio of the lubricant are large, as with the Comparative Examples, dispersion does not occur as easily, and the effects for lubricating the pulverized powder were not adequately attained. From this, in the milling step, by adding a lubricant whose particle size ratio in particular is 1.5 or less, it is possible to ensure the pulverizing properties of the raw material alloy in the pulverizing step, and the orientation of the raw material powder in the compacting step in a magnetic field, as well as attain high compacted body strength and high residual magnetic flux density (Br) of the ultimately obtained sintered magnet. In other words, it was proven that with a lesser amount of lubricant than the conventional art, compacted body strength or residual magnetic flux density (Br) equivalent to the conventional art can be attained.

### EXAMPLE 3

An R—Fe—B system sintered magnet was produced as described below.

Metals or alloys which were to become the raw material were blended together so as to form a composition consisting essentially of 24.5% by weight of Nd, 6.0% by weight of Pr, 1.8% by weight of Dy, 0.5% by weight of Co, 0.2% by weight of Al, 0.07% by weight of Cu, 1.0% by weight of B and the balance being Fe. The resultant raw material was melted and cast into a raw material alloy thin plate by strip casting. The obtained raw material alloy thin plate underwent hydrogen-pulverizing, and the resultant product was subjected to mechanical pulverizing using a Brown mill, whereby a pulverized powder was obtained.

This pulverized powder was charged with oleic amide as a lubricant. Subsequently, a milled powder was obtained using a jet mill.

As the lubricant charged during the milling, a plurality of kind shaving a differing particle size were prepared. Using commercially available oleic amide (Product name: “Neutron”, manufactured by Nippon Fine Chemical Co., Ltd.) as a lubricant, this lubricant was frozen with liquid nitrogen, and then pulverized by a mill. The pulverized lubricant was classified using a sieve, to obtain the below 3 kinds of lubricant.

(1) particle size of less than 100 μm

(2) particle size of 300 μm or more to less than 425 μm

(3) particle size of 425 μm or more

Here, the additive amount of lubricant was from 0.01 to 0.17% by weight of the pulverized powder.

Next, the milled powders produced using these lubricants were compacted in a magnetic field. Specifically, they were compacted in a 15 kOe magnetic field at a pressure of 137 MPa, whereby compacted bodies were obtained. The magnetic field direction was perpendicular to the press direction. These compacted bodies were sintered at 1,030° C. for 4 hours, whereby sintered bodies were obtained.

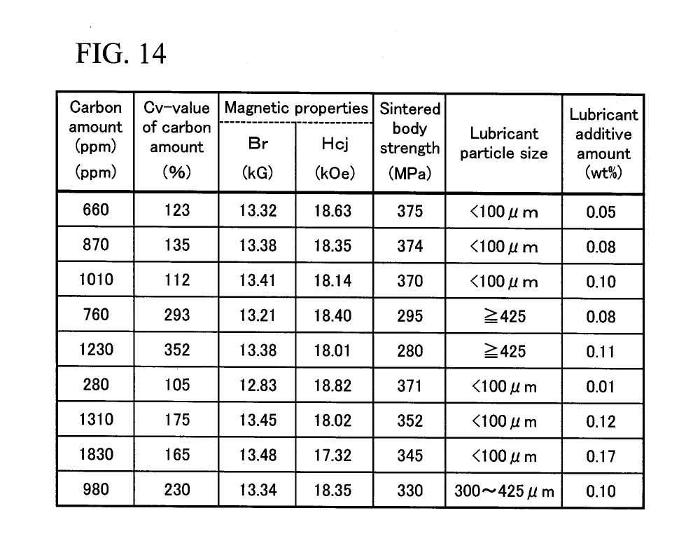

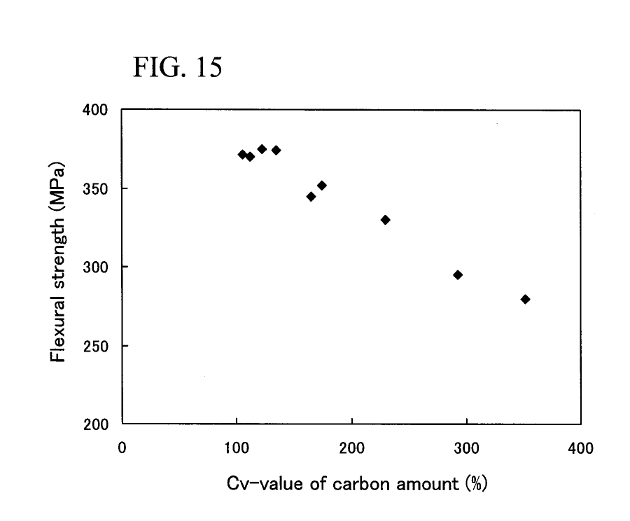

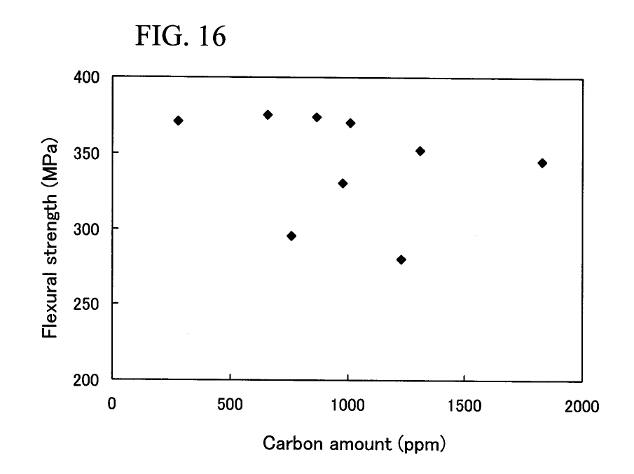

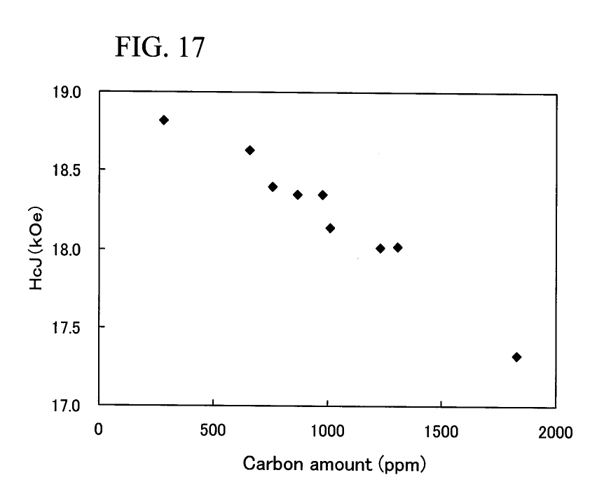

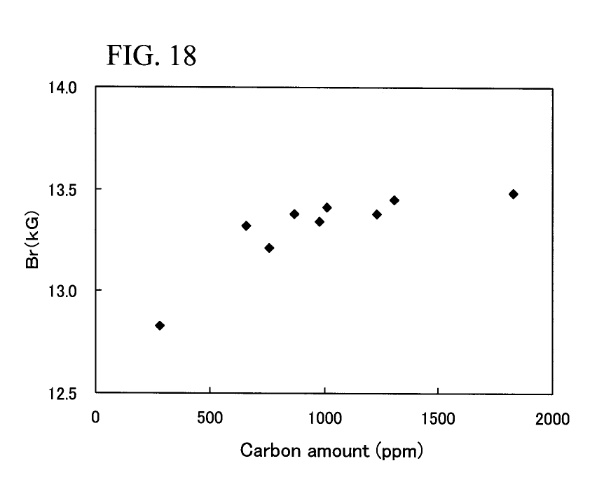

The obtained sintered bodies were subjected to an aging treatment (conditions: 900° C.×1 hour, 540° C.×1 hour), whereby rare earth sintered magnets were obtained. The carbon amount (mass spectrometry) and cv-value of the carbon amount (hereinafter, simply referred to as “cv-value”) of these rare earth sintered magnets were measured. The cv-values were determined by dividing the standard deviation of the carbon amount measured under the below conditions by the mean value of the carbon amount. In addition, coercive force (HcJ) and residual magnetic flux density (Br) were measured using a B—H tracer. Flexural strength was also measured. The measuring conditions for flexural strength are described below. The results for the above measurements are illustrated in FIG. 14. A graph of the relationship between cv-value and flexural strength is illustrated in FIG. 15, a graph of the relationship between carbon amount and flexural strength is illustrated in FIG. 16, a graph of the relationship between carbon amount and coercive force (HcJ) is illustrated in FIG. 17, and a graph of the relationship between carbon amount and residual magnetic flux density (Br) is illustrated in FIG. 18. Further, FIG. 14 describes the particle size ((1) to (3)) of the used lubricants and the additive amounts.

<Conditions for cv-Value Measurement>

After rupturing at the plane containing the orientation direction of the sintered body, the samples were analyzed by sampling in an Auger electron spectroscopy analyzer (hereinafter, “Auger”).

The sampling was performed by rupturing the samples in air, mounting onto a sample holder, tilting the samples at a 30 degree incline, and subjecting to Ar etching (3 kV Ar ions) while rotating.

The employed Auger was a 680 Model FE-Auger manufactured by ULVAC PHI Inc.

The analysis conditions were an accelerating voltage of 10 kV, a radiation current of 10 nA, and mapping set to a magnification of 1,500 times (256×256 pixels).

<Flexural Strength Measuring Conditions>

Measurement was performed under the below conditions according to a four-point bending test (in accordance with JIS R1601).

Sample form: 40×10×5 mm (5 mm direction was the orientation direction)

Distance between support points: 30 mm

Distance between loads: 10 mm

Crosshead speed: 0.5 mm/min

As illustrated in FIGS. 14 to 16, it can be seen that the flexural strength of the rare earth sintered magnets was influenced more by cv-value than by carbon amount. According to the present invention a flexural strength of 350 MPa or greater, and even of 360 MPa or greater, can be attained.

Further, as illustrated in FIGS. 14, 17 and 18, residual magnetic flux density (Br) tends to increase and coercive force (HcJ) tends to decrease if the carbon amount increases. In particular, at a carbon amount of less than 500 ppm, residual magnetic flux density (Br) is low, and if carbon amount exceeds 1,500 ppm coercive force (HcJ) is low.

According to the present invention, while having a flexural strength of not less than 350 MPa, the magnetic properties can provide a residual magnetic flux density (Br) of 13 kG or greater, and even of 13.3 kG or greater, and a coercive force (HcJ) of 18 kOe or greater, and even of 18.2 kOe or greater.

From the above results, it can be seen that in order to obtain a rare earth sintered magnet having high residual magnetic flux density (Br) and coercive force (HcJ), and strong mechanical strength, the cv-value in the sintered body should be controlled.

### EXAMPLE 4

An R—Fe—B system sintered magnet was produced as described below.

Metals or alloys which were to become the raw material were blended together so as to form a composition consisting essentially of 24.5% by weight of Nd, 6.0% by weight of Pr, 1.8% by weight of Dy, 0.5% by weight of Co, 0.2% by weight of Al, 0.07% by weight of Cu, 1.0% by weight of B and the balance consisting of Fe. The resultant raw material was melted and cast into a raw material alloy thin plate by strip casting. The obtained raw material alloy thin plate underwent hydrogen-pulverizing, and the resultant product was subjected to mechanical pulverizing using a Brown mill, whereby a pulverized powder was obtained.

This pulverized powder was charged with oleic amide as a lubricant. Subsequently, a milled powder was obtained using a jet mill, by milling in a high-pressure nitrogen gas atmosphere.

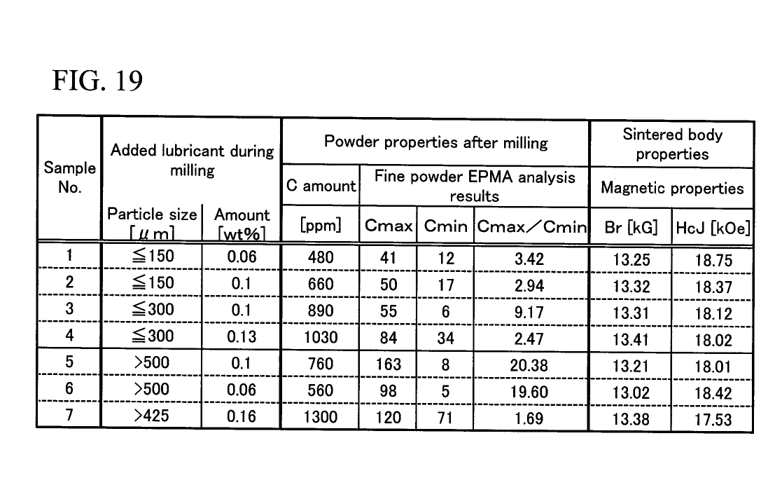

As the lubricant added during the milling, a plurality of kind shaving a different particle size were prepared. Using commercially available oleic amide (Product name: “Neutron”, manufactured by Nippon Fine Chemical Co., Ltd.) as a lubricant, this lubricant was frozen with liquid nitrogen, and then pulverized by a mill. The pulverized lubricant was classified to obtain lubricants having different particle sizes as illustrated in FIG. 19. The additive amounts thereof are also shown in FIG. 19.

The carbon amount (mass spectrometry) and Cmax/Cmin were determined for the obtained milled powders, and these results are illustrated in FIG. 19. Although the Cmax/Cmin measuring conditions were as described below, the X-ray intensity of the characteristic X-rays of carbon was given as the count value determined by the below-described FE-EPMA (Field Emission Electron Probe Micro Analyzer). Therefore, Cmax/Cmin can be given as the ratio between the maximum value and minimum value of the carbon (C) count values. The carbon (C) count value was measured for 50 particles removed from each milled powder to determine its Cmax/Cmin.

Used device: FE-EPMA JXA-8500 F manufactured by JEOL Ltd.

Measuring conditions

Accelerating voltage: 8.0 kV

Radiation current: 3.0×10⁻⁸ A

Measuring time: 70 ms

Spectrometer: LDE (Layered Dispersion Element)

Next, the milled powders produced using these lubricants were compacted in a magnetic field. Specifically, they were compacted in a 15 kOe magnetic field at a pressure of 137 MPa, whereby compacted bodies were obtained. These compacted bodies were sintered at 1,030° C. for 4 hours, whereby sintered bodies were obtained.

The obtained sintered bodies were subjected to an aging treatment (conditions: 900° C.×1 hour, 540° C.×1 hour), whereby rare earth sintered magnets were obtained. For these rare earth sintered magnets, residual magnetic flux density (Br) and coercive force (HcJ) were measured using a B—H tracer. These results are illustrated in FIG. 19.

As illustrated in FIG. 19, the rare earth sintered magnets of samples Nos. 1 to 4 produced using milled powders whose Cmax/Cmin was within the range of the present invention, attained a residual magnetic flux density (Br) of 13.25 kG or greater and a coercive force (HcJ) of 18 kOe or greater. In contrast, the rare earth sintered magnets of samples Nos. 5 and 6 produced using milled powders whose Cmax/Cmin was a high at around 20, had a lower residual magnetic flux density (Br) than those of the rare earth sintered magnets of samples Nos. 1 to 4. This was because the dispersion state of the lubricant in the milled powders used for the rare earth sintered magnets of samples Nos. 5 and 6 was poor, whereby the orientation could not be achieved to match the amount of charged lubricant. In addition, the rare earth sintered magnet of sample No. 5 had a low coercive force (HcJ). This is thought to be as a result of the added lubricant segregating out in the milled powder for the rare earth magnet of sample No. 5, whereby the rare earth carbide in the rare earth sintered magnet was segregated out.

Even though the rare earth sintered magnet of sample 7 had a low Cmax/Cmin of 1.69, its coercive force (HcJ) was low. This is believed to be because the amount of lubricant added during the milling was large, so that the carbon (C) amount after the milling was also large.

As described above, by specifying the milled powder carbon amount and the Cmax/Cmin, the residual magnetic flux density (Br) and coercive force (HcJ) of a rare earth sintered magnet can be increased to a high value.

### EXAMPLE 5

An R—Fe—B system sintered magnet was produced as described below.

The composition of the raw material alloy was 24.5% by weight of Nd, 6.0% by weight of Pr, 1.8% by weight of Dy, 0.5% by weight of Co, 0.2% by weight of Al, 0.07% by weight of Cu, 1.0% by weight of B, the balance consisting of Fe. Metals or alloys which were to become the raw material were blended together so as to form the above-described composition, and the resultant raw material was melted and cast into a raw material alloy thin plate by strip casting.

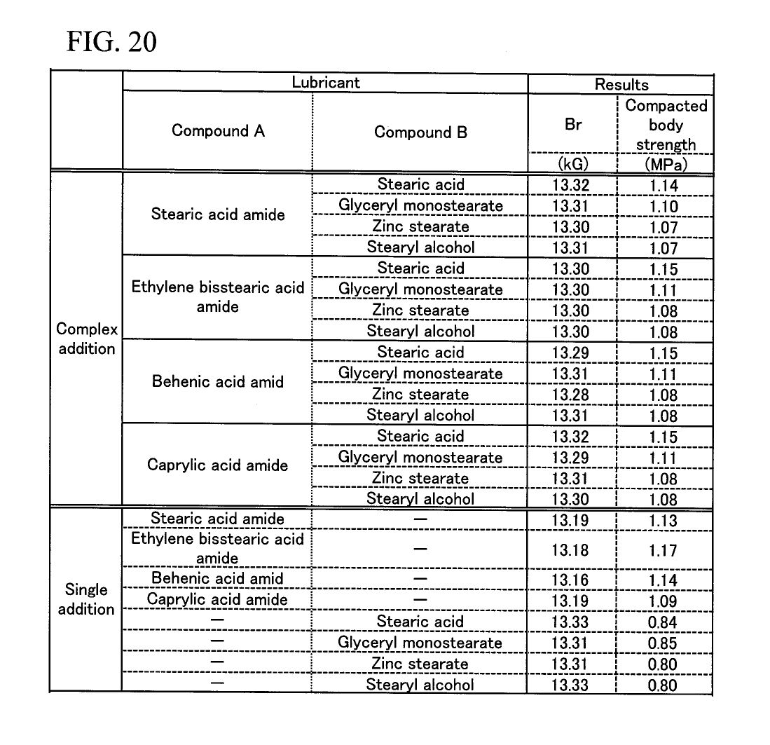

The obtained raw material thin plate underwent hydrogen-pulverizing, and the resultant product was subjected to mechanical pulverizing using a Brown mill, whereby a pulverized powder was obtained. As a lubricant (pulverizing aid) for the pulverized powder, 0.05% by weight of compound A and 0.05% by weight of compound B as illustrated in FIG. 20 were each added. Next, using a jet mill, milling was performed in a high-pressure nitrogen gas atmosphere until the mean particle size D50 was 4.1 μm, to thereby obtain raw material alloy powders.

The obtained powders were compacted in a magnetic field, whereby compacted bodies having a fixed shape were obtained. The compacting in a magnetic field was performed by compacting the raw material alloy powders in a 15 kOe magnetic field at a pressure of 147 MPa. The magnetic field direction was perpendicular to the press direction. The obtained compacted bodies have two different dimensions, that is, 20 mm×18 mm×6.5 mm, and 20 mm×18 mm×13 mm. The former compacted bodies were then used for measuring the flexural strength as the strength of the compacted body in the below manner.

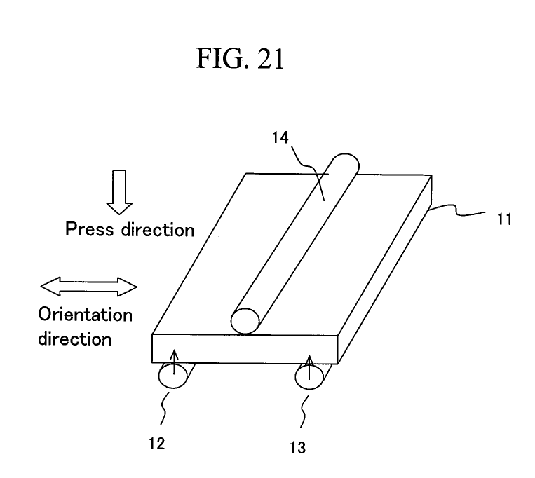

Flexural strength measurement was carried out in accordance with the Japanese Industrial Standard JIS R1601. Specifically, as illustrated in FIG. 21, a compacted body 11 of 20 mm×18 mm×6.5 mm was mounted onto two round-bar supports 12, 13, and a load was applied by placing a round-bar support 14 onto a center location of the compacted body 11. The direction in which flexural pressure was applied was the press direction. The radius of the round-bar supports 12, 13, 14 was 3 mm, the distance between support points was 10 mm, and the load point moving rate was 0.5 mm/min. The support 14 was arranged so as to be parallel to the longitudinal direction of the compacted body 11. Measuring was performed with a sample number “n” of 10.

Further, residual magnetic flux density (Br) was evaluated using the compacted bodies of 20 mm×18 mm×13 mm as an evaluation sample. The compacted bodies were sintered at 1,030° C. for 4 hours, and the sintered bodies were then subjected to an aging treatment (conditions: 900° C.×1 hour, 530° C.×1 hour). The surface of the obtained sintered bodies was ground to thereby produce a rectangular sample. The residual magnetic flux density (Br) of these samples was evaluated using a B—H tracer.

As illustrated in FIG. 20, samples for comparison were produced in the same manner as described above, except that 0.1% by weight of only one of compound A or compound B was added (single addition) as the lubricant. The strength and residual magnetic flux density (Br) of the resultant compacted bodies and sintered magnets were evaluated, and these results are illustrated in FIG. 20.

As illustrated in FIG. 20, in the case of adding only compound A, while the compacted body strength was 1.05 MPa or more, Br was below 13.2 kG. In the case of adding only compound B, while Br was above 13.2 kG, the compacted body strength was below 0.9 MPa. In other words, when only compound A was added, a high compacted body strength could be attained, but residual magnetic flux density (Br) was low, while if only compound B was added, high magnetic properties could be attained, but compacted body strength was low.

In contrast, when both compound A and compound B were added together, Br was above 13.2 kG and compacted body strength also was above 1.05 MPa. That is, it was confirmed that by adding compound A and compound B together, high compacted body strength and high residual magnetic flux density (Br) could be combined. Moreover, it can be seen that the obtained compacted body strength and residual magnetic flux density (Br) are equal to or better than the compacted body strength for when compound A was added alone and the residual magnetic flux density (Br) for when compound B was added alone.

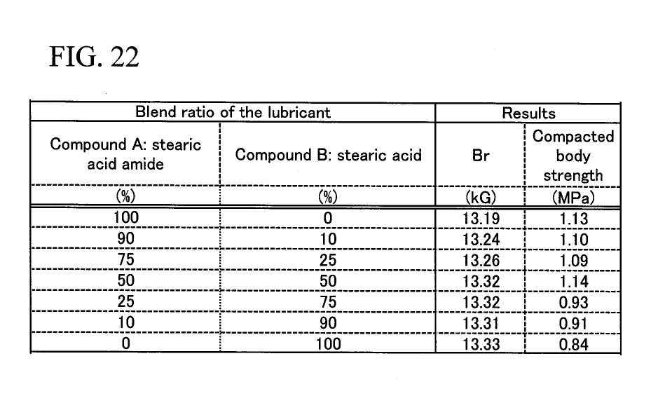

Samples were produced in the same manner as described above, except that the stearic acid amide of compound A and the stearic acid of compound B were mixed as the lubricant in the mixing ratio shown in FIG. 22 in a total of 0.1% by weight. The strength and residual magnetic flux density (Br) of the resultant compacted bodies and sintered magnets were evaluated, and these results are illustrated in FIG. 22.

As illustrated in FIG. 22, if the blend ratio of compound B reaches 75% or more, the compacted body strength falls below 1.05 MPa. Therefore, it can be said that it is preferable to mix so that the mixing ratio between compound A and compound B is from 9:1 to 1:2 on a weight basis. Further, an even more preferable mixing ratio between compound A and compound B is from 9:1 to 1:1, since a high Br of 13.25 kG can be attained, and especially preferably is roughly 1:1.

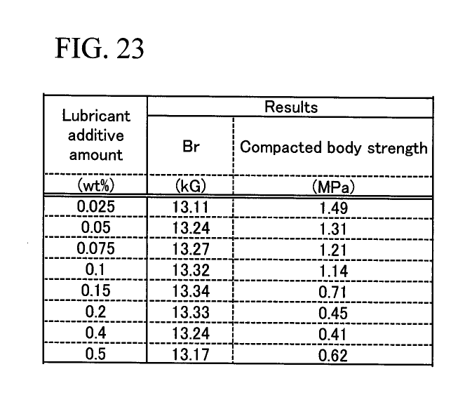

Samples were produced in the same manner as described above, except that, as the lubricant, the mixing ratio of stearic acid amide of compound A to the stearic acid of compound B was 1:1, and that the additive amounts were as shown in FIG. 23. The strength and residual magnetic flux density (Br) of the resultant compacted bodies and sintered magnets were evaluated, and these results are illustrated in FIG. 23.

As illustrated in FIG. 23, if compound A and compound B are mixed at roughly 1:1, with the total additive amount of the lubricant in the range of 0.075 to 0.1% by weight, it can be seen that Br is 13.2 kG or more, and the compacted body strength is 1.05 MPa. Based on this, it can be said that, if compound A and compound B are mixed at roughly 1:1, it is preferable to mix so that the total additive amount of the lubricant is in the range of 0.075 to 0.1% by weight.

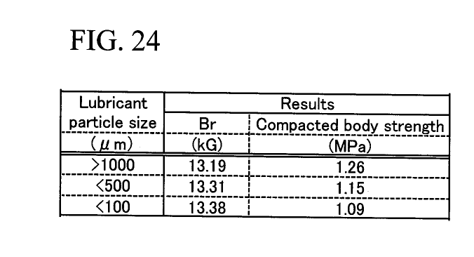

Samples were produced in the same manner as described above, except that, as the lubricant, the stearic acid amide of compound A and the stearic acid of compound B used the particle sizes illustrated in FIG. 24, that the mixing ratio of the stearic acid amide to the stearic acid was 1:1, and that the total additive amount was 0.1% by weight. The strength and residual magnetic flux density (Br) of the resultant compacted bodies and sintered magnets were evaluated, and these results are illustrated in FIG. 24.

As illustrated in FIG. 24, it can be seen that Br is 13.25 kG or more if the particle size of the lubricant is no greater than 1,000 μm, and that the compacted body strength is 1.10 or more if the particle size of the lubricant is no less than 100 μm. Therefore, it was confirmed that by setting the particle size (mean particle size) of the lubricant to be no greater than 1,000 μm, both residual magnetic flux density (Br) and compacted body strength can be particularly increased. A more preferable range for the lubricant particle size is no greater than 800 μm, and an especially preferable range is no greater than 500 μm.

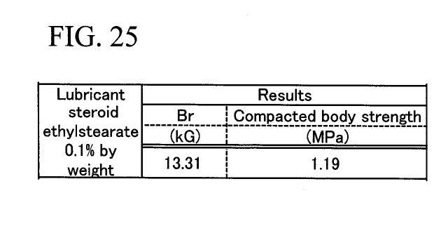

Samples were produced in the same manner as in Example 1, except that, 0.1% by weight of steroid ethyl stearate was added as the lubricant into the raw material alloy coarse powder. The resultant compacted bodies and sintered magnets were evaluated, and these results are illustrated in FIG. 25.

As illustrated in FIG. 25, it was also confirmed that in the same manner as when compounds A and B were added, when steroid ethyl stearate was added, Br was 13.2 kG or more and the compacted body strength was 1.05 MPa.

Thus, by adding a lubricant to a raw material alloy in the milling step, a product can be obtained whose compacted body strength is high, and whose residual magnetic flux density (Br) of the sintered magnet that is ultimately obtained is high, while ensuring the pulverizing properties of the raw material alloy in the pulverizing step and the orientation of the pulverized powder in the compacting step in a magnetic field.

1. A rare earth sintered magnet comprising a sintered body whose carbon amount as determined by mass spectrometry is between 500 and 1,500 ppm, wherein a cv-value of carbon amount on a rupture plane thereof is no greater than 200.

2. The rare earth sintered magnet according to claim 1, wherein the cv-value of carbon amount is no greater than 150.

3. The rare earth sintered magnet according to claim 1, wherein the cv-value of carbon amount is no greater than 130.

4. The rare earth sintered magnet according to claim 1, wherein the carbon amount is between 700 and 1,300 ppm.

5. The rare earth sintered magnet according to claim 1, wherein the carbon amount is between 800 and 1,200 ppm.

6. The rare earth sintered magnet according to claim 1, wherein the rare earth sintered magnet is an R—Fe—B system sintered magnet which comprises a R₂Fe₁₄B compound (wherein R represents one or more elements selected from among Y, La, Ce, Pr, Nd, Sm, Eu, Gd, Tb, Dy, Ho, Er, Tm, Yb and Lu).

7. The rare earth sintered magnet according to claim 6, having a flexural strength of 350 MPa or greater, a residual magnetic flux density (Br) of 13 kG or greater, and a coercive force (HcJ) of 18 kOe or greater.

8. A raw material alloy powder for a rare earth sintered magnet to be used for compacting in a magnetic field, characterized in that the raw material alloy powder has carbon amount of no greater than 1,200 ppm as determined by mass spectrometry, and a Cmax/Cmin value of 15 or less wherein Cmax and Cmin respectively represent a maximum value and a minimum value of X-ray intensity of characteristic X-rays of carbon as determined by EPMA (Electron Probe Micro Analyzer).

9. A process for producing a rare earth sintered magnet, comprising the steps of:
preparing a compacted body by compressing in a magnetic field a raw material alloy powder, which has a carbon amount of no greater than 1,200 ppm as determined by mass spectrometry and a Cmax/Cmin value of 15 or less wherein Cmax and Cmin respectively represent a maximum value and a minimum value of X-ray intensity of characteristic X-rays of carbon as determined by EPMA (Electron Probe Micro Analyzer); and
sintering the compacted body.

10. The process for producing a rare earth sintered magnet according to claim 9, wherein the raw material alloy powder has a carbon amount of no greater than 1,000 ppm as determined by mass spectrometry, and a Cmax/Cmin value of 10 or less.

11. The process for producing a rare earth sintered magnet according to claim 9, wherein a lubricant comprising an organic compound is coated on a surface of the raw material alloy powder.

12. The process for producing a rare earth sintered magnet according to claim 9, wherein the raw material alloy powder has been milled with lubricant particles having a particle size of 425 μm or less added therein.

13. The process for producing a rare earth sintered magnet according to claim 11, wherein the lubricant particles have been obtained by pulverizing a solid lubricant.

14. The process for producing a rare earth sintered magnet according to claim 9, wherein the raw material alloy powder comprises an R₂Fe₁₄B compound wherein R represents one or more elements selected from among Y, La, Ce, Pr, Nd, Sm, Eu, Gd, Tb, Dy, Ho, Er, Tm, Yb and Lu.

15. A process for producing a rare earth sintered magnet comprising the steps of:
obtaining a pulverized powder by pulverizing a raw material alloy with lubricant particles having a particle size of 425 μm or less added therein;
obtaining a compacted body by applying a magnetic field to the pulverized powder and then compressing the powder; and
sintering the compacted body.

16. The process for producing a rare earth sintered magnet according to claim 15, wherein the raw material alloy is pulverized by charging the lubricant particles into a jet mill along with the raw material alloy.

17. The process for producing a rare earth sintered magnet according to claim 15, wherein the milled powder has a mean particle size from 2.5 to 10 μm.

18. The process for producing a rare earth sintered magnet according to claim 15, wherein the lubricant particles have been obtained by freezing and then pulverizing a solid lubricant.

19. The process for producing a rare earth sintered magnet according to claim 15, wherein the particle size of the lubricant particles is no greater than 1.5 times the particle size of the raw material alloy.

20. The process for producing a rare earth sintered magnet according to claim 15, wherein the lubricant particles comprise a compound A represented by the general formula R₁, —CONH₂ or R₁—CONH—R₃—HNCO—R₂, and a compound B represented by one selected from the group consisting of R₄—OCO—R₅, R₄—OH, and (R₄—COO)ₙM wherein R_{1 to 4} denote CₙH₂ₙ₊₁ or CₙH₂ₙ₋₁; R₅ denotes H, CₙH₂ₙ₊₁ or CₙH₂ₙ₋₁; M denotes a metal; and n is an integer.

21. A process for producing a rare earth sintered magnet comprising the steps of:
pulverizing a lubricant to obtain lubricant particles having a particle size no greater than 1.5 times a particle size of the raw material alloy;
obtaining a pulverized powder by pulverizing the raw material alloy with the lubricant particles added therein;
obtaining a compacted body by applying a magnetic field to the pulverized powder and then compressing the powder; and
sintering the compacted body.

22. A process for producing a rare earth sintered magnet comprising the steps of:
obtaining a compacted body by applying a magnetic field to a raw material alloy powder comprising a compound A represented by the general formula R₁—CONH₂ or R₁—CONH—R₃—HNCO—R₂ and a compound B represented by one selected from the group consisting of R₄—OCO—R₅, R₄—OH, and (R₄—COO)ₙM wherein R_{1 to 4} denote CₙH₂ₙ₊₁ or CₙH₂ₙ₋₁; R₅ denotes H, CₙH₂ₙ₊₁ or CₙH₂ₙ₋₁; M denotes a metal; and n is an integer, and then compressing the powder; and
sintering the compacted body.
